(19) United States
(12) Patent Application Publication
(10) Pub. No.: US 2009/0038485 A1
(43) Pub. Date: Feb. 12, 2009

(54) Food grinding and chopping devuce & method

(75) Inventors: Susan R. Kavanaugh, Florence, AL (US); Rodney W. Robbins, Florence, AL (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Robbins Industries, Inc.

(21) Appl. No.: 11/890,840

(22) Filed: Aug. 7, 2007

(51) Int. Cl. A47J 43/00; B02C 19/08; B65D 21/02; A23P 1/00

(52) U.S. Cl. 99/537; 241/169.2; 206/514; 426/481

(57) ABSTRACT

A mortar and pestle and a chopping bowl are provided with bottom walls which can engage one another when one is placed atop of the other when the bottom unit is upside-down. The combined units provide a stable surface to either grind or chop food articles on, and provide for compact storage of the items when not in use.

This invention relates to food grinding and chopping devices and methods.

Devices available for grinding food substances have included the mortar and pestle for a very, very long time.

Similarly, devices available for chopping food items long have included the “mezzaluna”, a curved, often half-moon shaped cutting blade often with a curved bowl-shaped wooden chopping block type of receptacle. Such a device often is used in chopping herbs, garlic and other such food objects.

The combination of a mortar and pestle and a mezzaluna often are used, particularly in Italian cooking, for making pesto sauce, a sauce made from basil, garlic, olive oil, parmesan cheese and other ingredients.

Typically, the mezzaluna is used to chop the fresh basil leaves and garlic and the mortar and pestle are used to grind those ingredients together with olive oil into a paste.

Although a blender or food processor can be used to chop the basil leaves and garlic, many connoisseurs strongly believe that the sauce prepared using a mezzaluna and mortar and pestle is superior to one prepared using motorized food processing.

The mortar and pestle and mezzaluna also are used to make salsa and other similar food items.

One of the problems with the use of mortar and pestle and mezzaluna devices in the past are that of providing storage space for the devices when not in use, and slippage of the mortar and mezzaluna bowls on the surfaces of countertops when they are in use.

It is an object of the invention to provide food grinding and chopping devices, and particularly mortar and pestles and food choppers in which the foregoing problems are either solved or greatly alleviated.

In accordance with the present invention, these objects are met by the provision of a mortar and pestle and chopper combination in which a bowl-shaped mortar and chopping bowl preferably have bottom walls which are shaped so as to engage one another when one is positioned atop the other with the other upside-down and resting on a horizontal support surface. This construction holds the bowls together while the upper bowl is being used for either grinding or chopping and simultaneously facilitates the space-saving storage of the devices when not in use.

The rims of the lower bowl and the upper bowl both preferably have elastomeric surfaces to cushion the impact of the rim against and damage to a surface upon which it sits, and to better grip the surface to prevent the assembled bowls from sliding on the counter top.

It also is preferred that one of the receptacles, preferably the mortar, have opposed notches for receiving the ends of the handle of a mezzaluna blade, so that the mortar and pestle and chopper can be stored together stacked upon one another with the mezzaluna blade and the pestle inserted into the cavity of the mortar bowl so that the assembly requires relatively little storage space, either on the counter top or in a cupboard when not in use.

The foregoing and other objects and advantages of the invention will be apparent from or set forth in the following description and drawings.

### IN THE DRAWINGS

FIGS. 1 through 4 are, respectively, a top plan view; a front elevation view; a bottom plan view; and a perspective view of a mortar bowl mounted on an upturned mezzaluna chopping bowl in the food grinding and chopping device & method;

FIG. 5 is a perspective view of the set shown in FIG. 4 with a chopping implement and a pestle stored in the mortar;

FIGS. 6, 7, 8, 9 and 10 are, respectively, a top plan view; a side elevation view; a front elevation view; a perspective view; and a bottom plan view of the chopping implement of the food grinding and chopping device & method;

FIGS. 11, 12, 13 and 14 are, respectively, a perspective view; a top plan view; a side plan view; and a bottom plan view of a pestle forming an implement of the food grinding and chopping device & method;

FIGS. 15, 16, 17, 18 and 19 are, respectively, a top plan view; a side elevation view; a bottom plan view; a perspective view; and a textured perspective view of the mortar bowl of the food grinding and chopping device & method; and

FIGS. 20, 21, 22 and 23 are, respectively, a bottom plan view; a side elevation view; a top plan view; and a bottom perspective view of the mezzaluna bowl of the food grinding and chopping device & method.

### GENERAL DESCRIPTION

Referring now to FIGS. 2, 4 and 5, a combination 30 of a mortar bowl 32 and a mezzaluna bowl 34 is shown with the mortar bowl mounted on the up-turned bottom wall of the mezzaluna bowl 34. Numeral 46 indicates the junction between the bottom walls of the two bowls.

The mortar bowl 32 is made of traditional mortar bowl material such as volcanic basalt rock. A pestle 38 is shown in FIG. 5 and in other FIGs. It is made of the same material as the mortar bowl 32.

The mortar bowl has three upwardly extending elastomeric projections or feet 40 which serve as frictional and cushioning members to separate and protect the counter top on which the bowl 32 is resting upside-down. A pair of spaced notches 44 in opposite sides of the upper rim of the bowl 32 are provided for receiving the ends of a wooden handle 52 of the mezzaluna blade 54 for storage purposes. The bowl 32 has a hemispherical internal receptacle area 42 into which items to be ground are placed and ground by use of the pestle 38, in a well known manner.

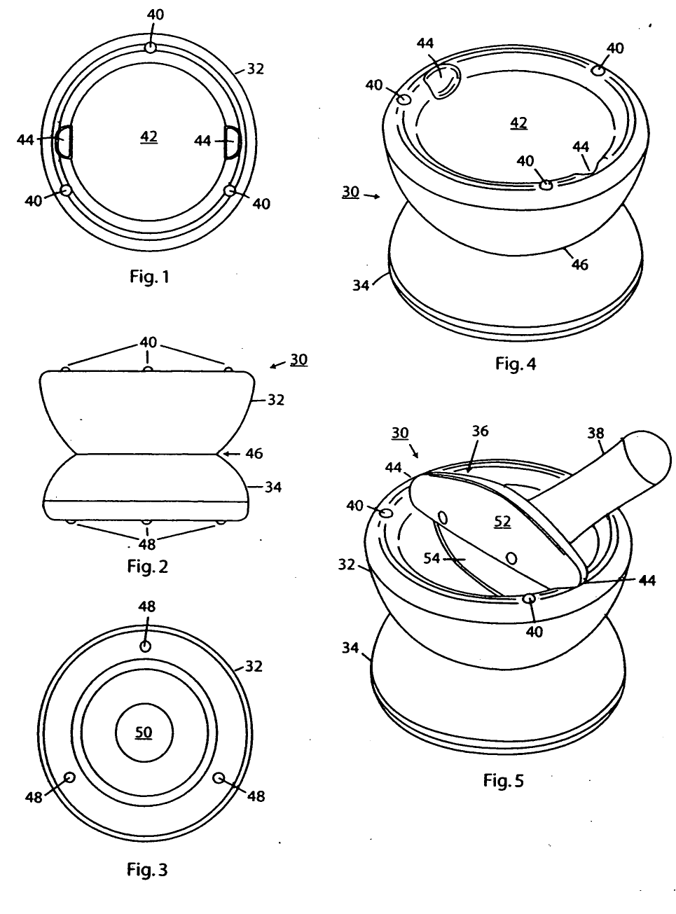

The mezzaluna or chopping bowl 34, which is shown in FIG. 2 as well as FIGS. 3 through 5, is a oblate hemispherical bowl with a receptacle 50 which is shaped to receive the oblate semicircular cutting blade 54 of the mezzaluna 36 to facilitate chopping of herbs, garlic and the like in the bowl. The upper rim of the bowl 34 has three projecting elastomeric feet 48 to serve as cushioning and gripping members to prevent the assembly 30 from sliding on and damaging a counter top on which the bowl rests when it is upside-down, as shown in FIGS. 2, 4 and 5.

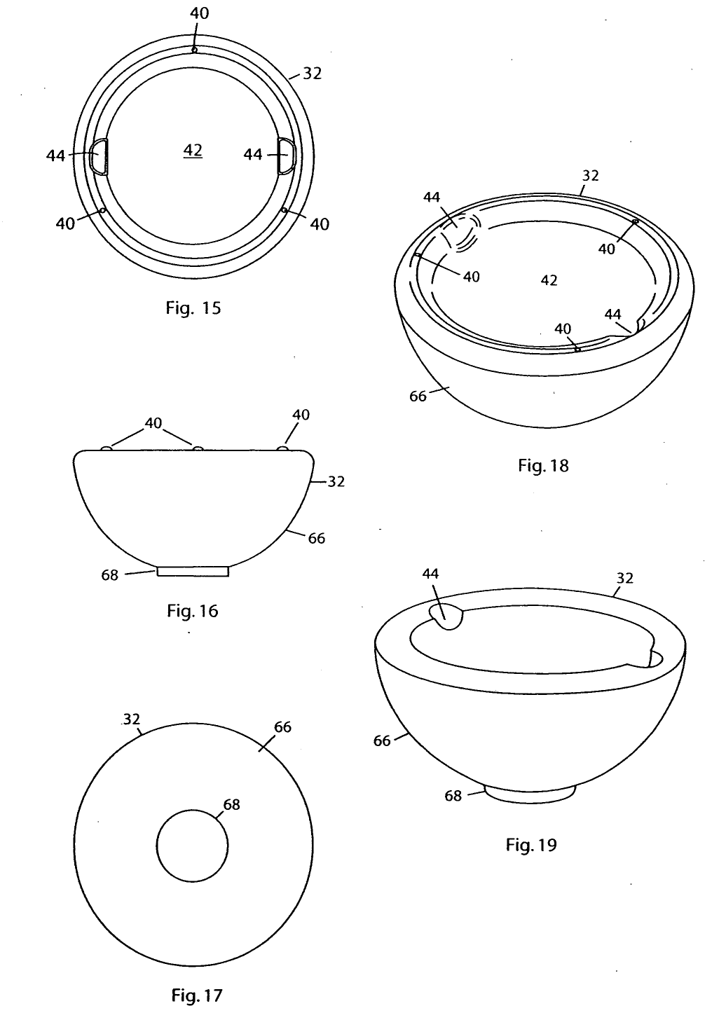

FIGS. 15 through 19 show the mortar bowl 32 by itself. The bottom wall of the bowl has a short cylindrical projection 68 extending from the bottom wall of the bowl.

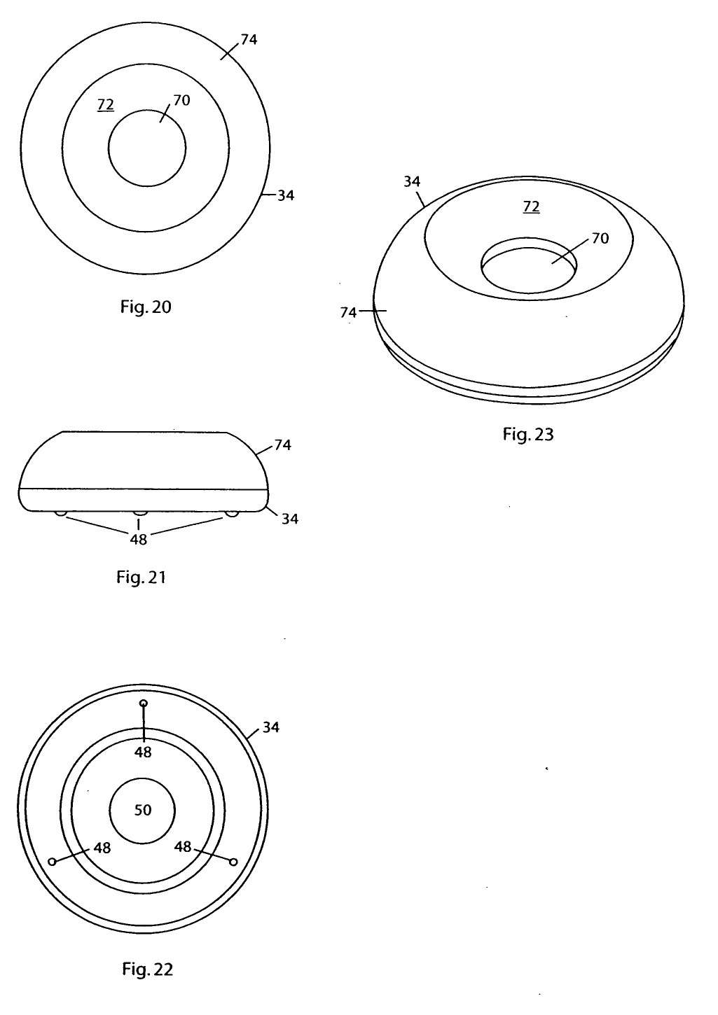

FIGS. 20-23 show the mezzaluna or cutting bowl 34 by itself. The bottom wall of the bowl has a hemispherical recess 72 matching the curvature of the exterior surface 66 (see FIGS. 18 and 19) of the mortar bowl 32. A central cylindrical recess or socket 70 is provided. It is slightly deeper than and slightly larger in diameter than the projection 68 from the bottom of the mortar bowl. Thus, when the mortar bowl 32 is resting atop of the upturned chopping bowl 34, the outer surface 66 of the bowl 32 fits into the curvature 72 and the projection 68 fits into the socket 70 so as to hold the mortar bowl and the chopping bowl together and resist sideways slippage of one relative to the other when either is being used for chopping or grinding while atop the other.

In use, one can start with either of the two bowls in the uppermost position. However, it will be assumed that the mortar bowl is being used first when mounted atop the bottom of the chopping bowl 34.

When the two are mounted as shown in FIGS. 2, 4 and 5, a stable mortar bowl is provided for grinding. Substantial amounts of sideways pressure can be applied to the pestle while grinding materials in the mortar bowl without the two bowls sliding relative to one another, or to the counter top.

When the combination 30 rests upon a horizontal surface, the rim of the chopping bowl 34 provides a broader area of support base for the upper bowl than if the upper bowl rested on its own bottom wall.

When it is desired to cut instead of grind, the contents of the mortar bowl are removed, and it is turned upside-down so that its feet 40 rest on a counter top or other support surface. Then, the mezzaluna chopper is used to chop herbs or garlic or other items in the chopping bowl 34. The chopping bowl is mounted on top of the bottom of the up-turned mortar bowl 32 and the two bowls are secured together by the same mechanism as that described above and shown in FIGS. 16, 19, 20 and 23.

In making a pesto sauce it might be preferred to start by chopping the herbs and garlic in the chopping bowl 34 and then up-turning the grinding bowl 32 and depositing the contents from the bowl 34 into it, and then adding the spices and olive oil, etc., and grinding them together to form a paste for a sauce.

For some salsas, some grinding of the soft vegetables forming the salsa sometimes is desired. In such a case, ingredients can be chopped in the chopping bowl, and then ground a little in the mortar bowl to make a superior salsa or sauce.

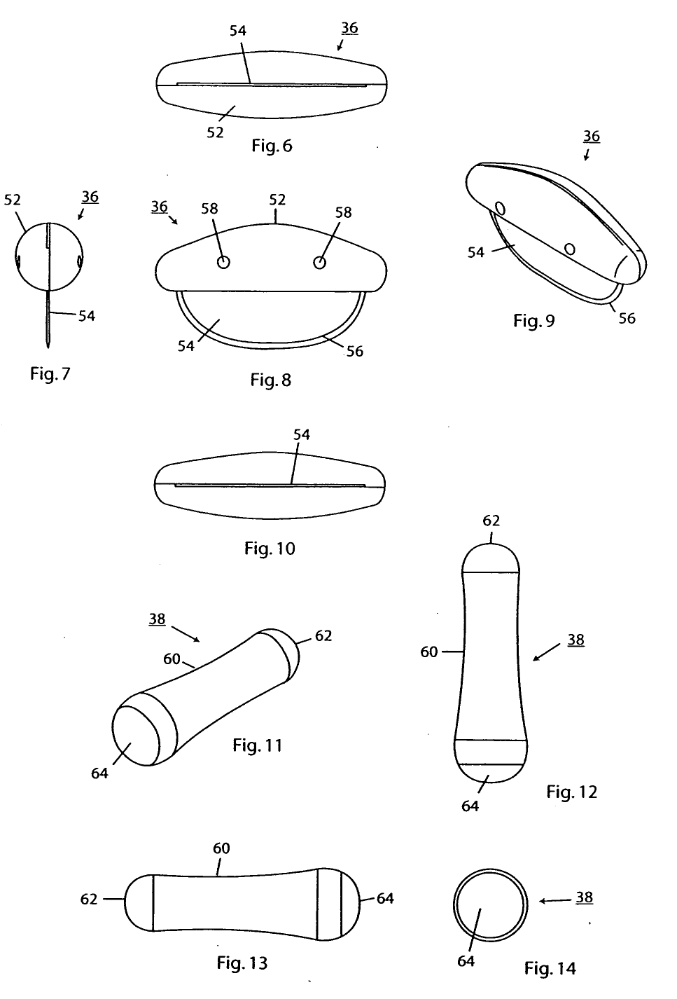

The chopping device 36 is shown in FIGS. 6-10 of the drawings.

The chopping device 36 consists of a stainless steel cutting blade which has an oblate semicircular shape and a sharp cutting edge 56. The curved shape of the blade is designed to match the curved inner surface of the wall of the mezzaluna bowl 34.

A wooden handle 52 is attached to the blade 54 by means of rivets or screws 58.

The pestle 38 is shown in FIGS. 11 through 14. It consists of an elongated body having a central portion 60 of a somewhat reduced diameter and two hemispherical end portions 62 and 64.

The chopping bowl 34 preferably is made of hardwood such as maple, beech, etc.

When the bowls 32 and 34 and the implements 36 and 38 have been cleaned and it is desired to store the combination 30, the chopper 36 is placed into the mortar bowl 32 with the ends of the handle 52 resting in the notches 44 in the mortar bowl rim, and the blade 54 descending into the cavity 42 of the bowl. Preferably, the blade 54 is shaped to fit into the recess 42 with some clearance.

The pestle 38 also is inserted into the bowl and the combination 30 is stored on a counter top or on a cupboard shelf or wherever else desired, occupying less of the surface area of the support surface than if the two bowls were separate.

The above description of the invention is intended to be illustrative and not limiting. Various changes or modifications in the embodiments described may occur to those skilled in the art. These can be made without departing from the spirit or scope of the invention.

What is claimed is:

1. A combination grinding and chopping device for food preparation, said device comprising
(a) a mortar receptacle for grinding food,
(b) a chopping receptacle for holding food to be chopped,
(c) said mortar receptacle having at least one side wall and a bottom wall,
(d) said chopping receptacle having at least one side wall and a bottom wall, and
(e) said bottom walls of said receptacles being shaped to engage one another when one of said receptacles is mounted onto the other of said receptacles bottom-wall-to-bottom-wall.

2. A device as in claim 1 in which one of said bottom walls has a shaped projection extending therefrom and the other of said bottom walls has a socket shaped to receive and engage said projection.

3. A device as in claim 2 in which said projections and said socket are cylindrical, with said projection being slightly smaller in diameter than said socket, and slightly shorter than said socket is deep.

4. A device as in claim 2 in which said projection extends from said bottom wall of said mortar receptacle and said socket is positioned in said bottom wall of said chopping receptacle.

5. A device as in claim 1 in which each of said receptacles is bowl-shaped and has an upper rim, and at least one elastomeric projection extending outwardly from each of said rims and positioned and shaped to act as a frictional bearing surface to support each of said receptacles on a flat support surface when said receptacle is upside-down.

6. A device as in claim 1 in which said mortar receptacle is made of a stone and said chopping receptacle is made of wood-like material.

7. A device as in claim 1 including a pestle, and a chopping device for chopping food in said chopping receptacle.

8. A device as in claim 7 in which said mortar receptacle has a pair of opposed recesses in its edge, said chopping device having an elongated handle which having a length matching the distance between said recesses so as to form a receptacle for holding said chopping device, said chopping device having a curved blade and said chopping receptacle has a curved inner surface whose curvature matches that of said curved blade.

9. A method of making food preparations by using mortar and pestle and a chopping device, said mortar and said chopping device each comprising a bowl-shaped receptacle with an outer wall and a bottom wall, each of said bottom walls having a structure for engaging the other when said receptacles are stacked atop one another bottom-to-bottom,
(a) placing one of said receptacles upside-down on a flat support surface,
(b) placing the other of said receptacles on top of the first-named receptacle, with said bottom wall structures engaged,
(c) using the upper one of said receptacles to prepare first food components by use of the upper one of said receptacles,
(d) inverting said receptacles and using the other of said receptacles, when it is the upper one, to prepare other food components, and
(e) combining said food components to provide said food preparation.

10. A method as in claim 9 in which said food preparation is selected from the group comprising sauces and salsas.

11. A method as in claim 10 in which said food preparation is a pesto sauce.

12. A method as in claim 9 in which each of said receptacles has an upper rim with at least one frictional bearing and cushioning surface area cushioned to hold the lower one of said receptacles against slippage on a horizontal surface.

13. A method as in claim 9 in which one of said receptacles is a mortar bowl and the other is a chopping bowl, and said chopping device includes a chopping blade with a handle, said blade being curved to match the internal curvature of said chopping bowl.
